(19) United States
(12) Patent Application Publication
(10) Pub. No.: US 2004/0193862 A1
(43) Pub. Date: Sep. 30, 2004

(54) Device with high storage capacity and several BIOS backup copies

(76) Inventor: Johnson Lin, Taipei (TW)

Correspondence Address: RABIN & BERDO, P.C., SUITE 500, 1101 14th STREET, N.W., WASHINGTON, DC, 20005, US

(21) Appl. No.: 10/402,156

(22) Filed: Mar. 31, 2003

(51) Int. Cl. G06F 9/00

(52) U.S. Cl. 713/1

(57) ABSTRACT

A device with high storage capacity and several basic input/output system (BIOS) backup copies is disclosed. It can at least back up one set of computer BIOS and, when the computer BIOS is damages, sends the backup copy to the computer system to maintain its normal operations.

### BACKGROUND OF THE INVENTION

1. Field of Invention

The invention relates to a basic input/output system (BIOS) backup device and, in particular, to a device that has high storage capacities and can simultaneously back up several sets of computer BIOS's.

2. Related Art

Normally, the computer system first looks for the basic input/output system (BIOS) program in the beginning when it is turned on. The power on procedure does not start until the BIOS is executed. The BIOS is firmware to the computer system, and is needed for the computer system to communicate with hardware and software.

The basic actions of the BIOS in a computer system are initialization, implementation, and parameterization of peripheral systems. Afterwards, the BIOS performs power on self test (POST). Once the peripheral interface initialization is completed, the BIOS starts to look for the location of the operating system (OS) and hands the controls over to the OS for the normal power on procedure.

Therefore, the BIOS is the first thing to start in a computer system. If this part has any problem, the computer system will not be able to operate normally. Since the BIOS has certain relations with the computer hardware, arbitrarily changing or modifying the computer BIOS may result in the computer system's being unable to start. Consequently, backing up the BIOS is extremely important.

The conventional way of backing up the BIOS always uses a floppy disc (FD) to store the BIOS program as a backup copy. However, the storage space on the FD is very limited and impossible to accommodate a large amount of BIOS programs. Therefore, how to effectively backing up the BIOS and, moreover, how to prevent errors occurring to the BIOS from affecting the normal operations of the computer system are two important issues to be solved.

### SUMMARY OF THE INVENTION

In view of the foregoing, the invention provides a device with high storage capacities and several BIOS backup copies. An objective of the invention is to solve the backup problem for the computer BIOS. It simultaneously prevents the inconvenience when the BIOS is damaged. The invention backs up at least one set of computer BIOS and, when the computer BIOS is damaged, sends the backup BIOS to the computer to maintain the normal operations of the computer system.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of an embodiment of the disclosed device with high storage capacities and several BIOS backup copies;

FIG. 2 is a flowchart of the backup steps according to the invention; and

FIG. 3 is a flowchart of the recovery steps according to the invention.

### DETAILED DESCRIPTION OF THE INVENTION

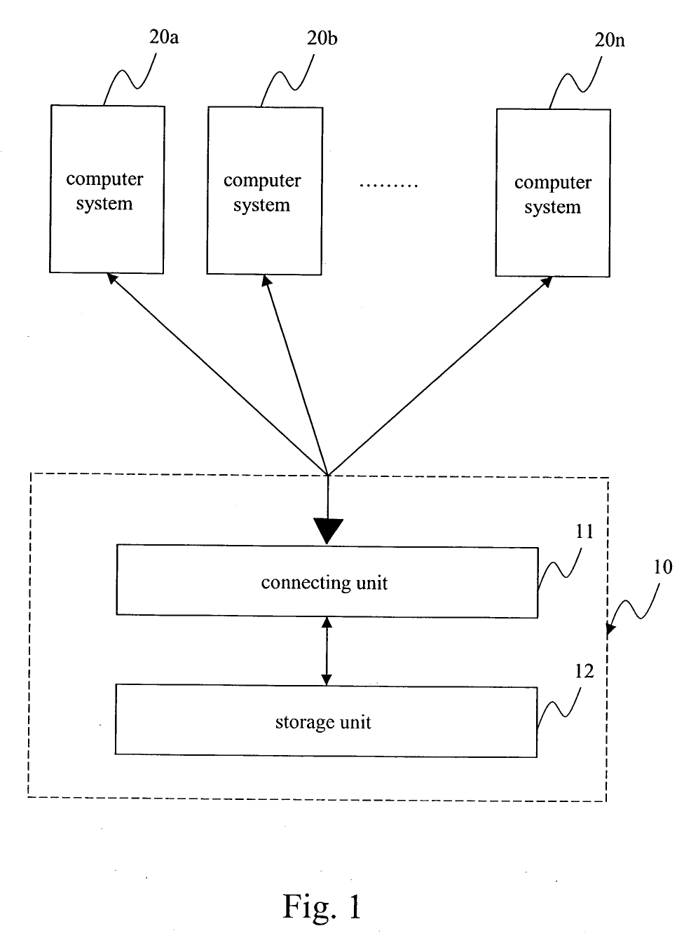

With reference to FIG. 1, the invention is a device 10 with high storage capacities and several BIOS backup copies. The device contains a connecting unit 11 and a storage unit 12. The connecting unit 11 is a universal serial bus (USB) interface and is connected to the computer systems 20a-n for transmitting the BIOS in each of the computer systems 20a-n. The storage unit 12 is flash read only memory (ROM), and contains a high-capacity storage sector and a BIOS backup program. The high-capacity storage sector can store the BIOS of at least one of the computer systems 20a-n for backup.

The BIOS backup program performs both backup steps and recovery steps. It is used to back up the BIOS. When the BIOS of any of the computer systems 20a-n has errors, the computer BIOS is compared with the backup BIOS. The backup BIOS associated with the computer system is executed and, at the same time, sent to the computer system for replacement.

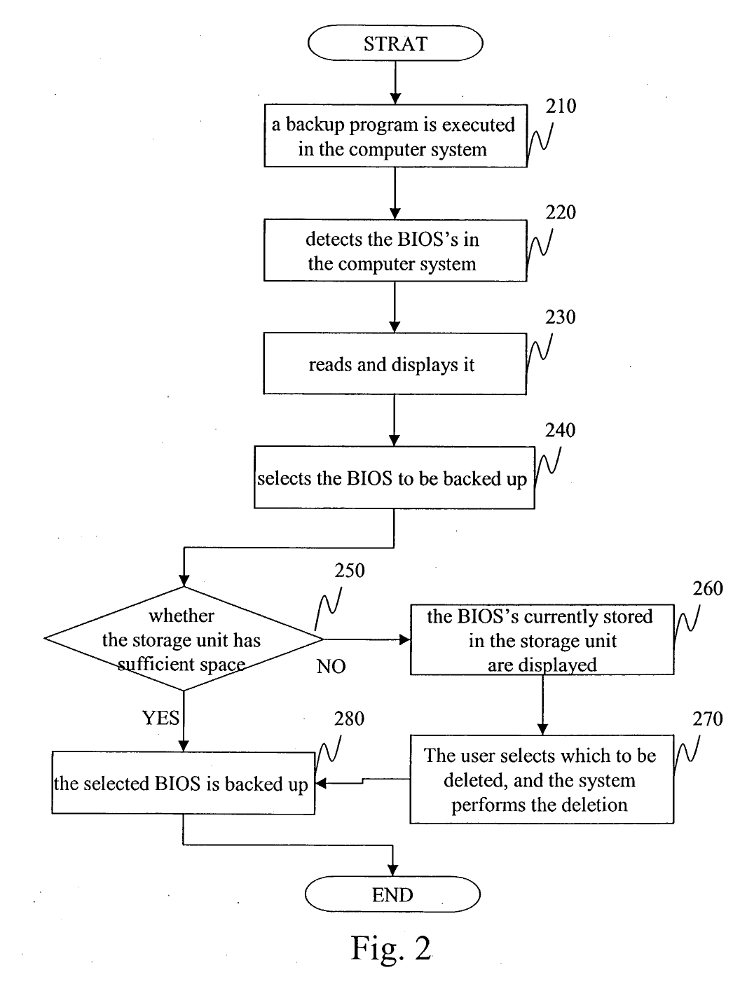

In the following paragraph, we use FIG. 2 to explain the backup procedure of the invention.

First, a backup program is executed in the computer system (step 210). The backup program can be run under the operating system (OS) or under the power on self test (POST). Afterwards, the invention detects the BIOS's in the computer system (step 220), and reads and displays it (step 230). The user selects the BIOS to be backed up (step 240). After the user finishes the selection, the computer system determines whether the storage unit has sufficient space (step 250). If the space is enough, the selected BIOS is backed up (step 280). If the space is insufficient, the BIOS's currently stored in the storage unit are displayed (step 260). The user selects which to be deleted, and the system performs the deletion (step 270). After the deletion, the BIOS to be backed up is then stored (step 280). This completes the steps of backing up a BIOS.

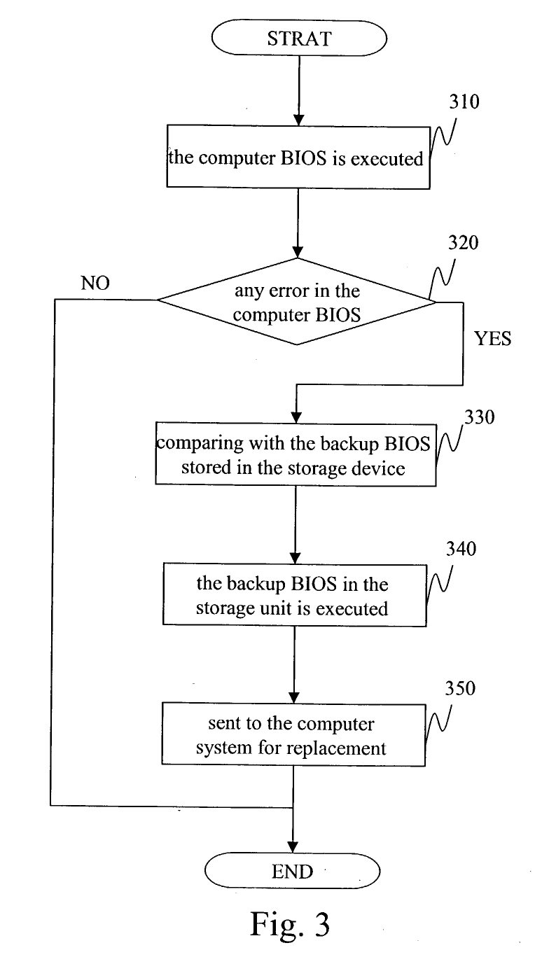

In the following, we use FIG. 3 to explain the BIOS recovery procedure. Once the backup procedure is done, the computer system performs normal operations. First, the computer BIOS is executed (step 310). The device simultaneously checks whether there is any error in the computer BIOS (step 320). If the computer BIOS is correct, then the computer system continues its normal tasks. If there is any error in the computer BIOS, then it is compared with the backup BIOS stored in the storage device (step 330). After the comparison, the backup BIOS in the storage unit is executed (step 340) to maintain the normal operations of peripheral devices. The backup BIOS is further sent to the computer system for replacement (step 350).

As described above, the disclosed interface BIOS backup device backs up the BIOS of a computer system. One advantage is that when the computer BIOS is damaged, the computer system can use the backup copy to keep working. Thus, normal operations of the computer will not be affected, and the computer system efficiency can be increased too. Another advantage of the invention is that the backup BIOS is sent to the computer system and is stored there. The invention uses a storage unit in replacement of a floppy disc as in the prior art. It has the advantage of high storage capacities for multiple backup copies. Therefore, it is much more convenient and useful.

Certain variations would be apparent to those skilled in the art, which variations are considered within the spirit and scope of the claimed invention.

What is claimed is:

1. A device with high capacities and a plurality of BIOS backup copies, comprising:
a connecting unit, which is connected to a computer system for transmitting the BIOS of the computer system; and
a storage unit, which is connected to the connecting unit and comprises:
a high capacity storage sector, which stores at least one computer BIOS backup copy; and
a BIOS backup program, which backs up the BIOS and, when the computer BIOS has an error, compares the computer BIOS with the BIOS backup copy in the storage unit, starts the backup BIOS and sends it to the computer system.

2. The device of claim 1, wherein the connecting unit is a universal serial bus (USB) interface.

3. The device of claim 1, wherein the storage unit is flash read only memory (ROM).

4. The device of claim 1, wherein the BIOS backup program comprises the steps of:
executing a program in the computer system to back up the BIOS;
detecting the BIOS of the computer system;
reading the BIOS of the computer system and displaying it; and
checking the space in the storage unit and storing the computer BIOS in the storage unit.

5. The device of claim 4, wherein the computer system executes the BIOS backup program in an operating system (OS) window.

6. The device of claim 4, wherein the computer system executes the BIOS backup program in power on self-test (POST) procedure.

7. The device of claim 4, wherein when the storage unit does not have sufficient space the BIOS backup program executes the steps of:
displaying the BIOS backup copies currently stored in the device; and
providing a deleting mechanism to increase the storage space in the device.

8. The device of claim 4, wherein after backing up the computer BIOS in the device, further comprises the steps of:
executing the computer BIOS;
checking the state of computer BIOS;
comparing the computer BIOS with the backup BIOS when the computer BIOS is found to have any error, and executing the backup BIOS; and
sending the backup BIOS to the computer system for replacement.

9. The device of claim 8, wherein the computer continues executing the computer BIOS if there is no error found.
